(19) United States
(12) Patent Application Publication
(10) Pub. No.: US 2014/0216276 A1
(43) Pub. Date: Aug. 7, 2014

(54) SNOW CONE AND SLUSHY DISPENSER

(71) Applicant: Richard J. Soderman, Clarkesville, GA (US)

(72) Inventor: Richard J. Soderman, Clarkesville, GA (US)

(21) Appl. No.: 14/251,310

(22) Filed: Apr. 11, 2014

Related U.S. Application Data
(63) Continuation-in-part of application No. 13/291,602, filed on Nov. 8, 2011, now Pat. No. 8,733,121.
(60) Provisional application No. 61/451,424, filed on Mar. 10, 2011.

(51) Int. Cl. A23G 9/28

(52) U.S. Cl. CPC A23G 9/28
USPC 99/484

(57) ABSTRACT

A frozen treat dispenser (11) dispenses a snow cone and/or a slushy, and has at least an ice storage bin (14) for storing ice (10), a cup de-nesting mechanism (49) to separate a cup from a stack having a plurality of cups, an ice grinder (21) to grind ice from the ice storage bin to produce snow (82), a flavor dispenser (25), a cup transport mechanism (23) to move the cup to a first position (40A) whereby the ice grinder can at least partially fill the cup with the snow and to a second position (40B) whereby the flavor dispenser can dispense at least one flavor onto the snow in the cup, and a processor (152) to control the operation of at least one of the cup de-nesting mechanism, the ice grinder, the flavor dispenser, the indexer, or a combination thereof.

### CROSS-REFERENCE TO RELATED APPLICATION

This application is a continuation-in-part of U.S. non-provisional patent application Ser. No. 13/291,602, filed Nov. 8, 2011, entitled “Snow Cone And Slushy Dispenser”, which claims the priority of U.S. provisional patent application No. 61/451,424 filed Mar. 10, 2011, entitled “Snow Cone Dispenser”, the disclosures of both of which are incorporated by reference in their entirety herein.

### TECHNICAL FIELD

This invention relates to ice making machines and, more particularly, to snow cone and slushy dispensers for such machines.

### BACKGROUND

Self-service ice-making and dispensing machines are widely available in many parts of the country. Such machines are often used by campers, travelers, and persons who have larger-than-normal ice needs, such as for a party or, unfortunately sometimes, when electric power fails or a primary refrigeration appliance fails. A visit to an ice-making and dispensing machine may be very entertaining for the children the first few times, as they enjoy the experience of putting the money in the machine, pressing the buttons, hearing the machinery working behind the front panel, and finally the thump-bump of a bag of freshly-processed ice or the swoosh of ice sliding down a chute into the ice chest. This thrill, however, soon wears off, and the children then express the viewpoint that the trip has become boring.

### SUMMARY

A frozen treat dispenser to dispense a frozen treat, such as a snow cone or a slushy, includes an ice storage bin, a cup de-nesting mechanism that separates a first cup from a stack having a plurality of cups, an ice grinder that grinds ice from the ice storage bin producing snow, a flavoring liquid dispenser that dispenses flavoring liquid into the snow, an indexer that moves the first cup to a first position where the ice grinder at least partially fills the first cup with the snow and to a second position where the flavoring liquid dispenser dispenses at least one flavoring liquid onto the snow in the first cup, and a processor controlling the operation of at least one of the cup de-nesting mechanism, the ice grinder, the flavoring liquid dispenser, or the indexer, wherein the cup de-nesting mechanism places the first cup in a starting position, and the indexer includes at least one first actuator that indexes the first cup from the starting position to the first position and that indexes the first cup from the first position to the second position.

In some embodiments, the cup de-nesting mechanism includes a plurality of spaced-apart sprockets, each sprocket having a plurality of teeth, the teeth being interposed between a lip of the first cup and a lip of a next cup in the stack, at least one first motor driving the sprockets in a direction to cause the teeth to engage the lip of the first cup and urging the first cup away from the stack, and a plurality of air jets directing air between the first cup and the next cup in the stack and urging the first cup away from the stack. Further, in some embodiments, a first pair of sprockets are on a first shaft and are generally disposed on one side of the first cup and a second pair of sprockets are on a second shaft and are generally disposed on an opposite side of the first cup from the one side, and the at least one first motor is connected to a least one of the first shaft or the second shaft. Further still, some embodiments further include a sprocket drive mechanism, for example, the at least one first motor driving the first shaft and the sprocket drive mechanism, and the sprocket drive mechanism driving the second shaft. Even further, in various embodiments, the sprocket drive mechanism is either a chain drive or a direct drive.

Moreover, in a number of embodiments, the ice grinder includes a conduit having a first opening that receives the ice from the ice storage bin and a second opening that discharges the snow, a grinding wheel that grinds the ice to produce the snow, a second motor that drives the grinding wheel, a cowling at least partially inside the conduit that allows the ice from the ice storage bin to enter the conduit via the first opening when the cowling is in a first cowling position, and that pushes ice in the conduit against the grinding wheel, a second actuator that drives the cowling, and a chute that directs the snow from the second opening toward the first cup. Further, some embodiments include a shaping mold that forms snow in the first cup into a desired shape and a third actuator that drives the shaping mold against the snow in the first cup. Further still, in some embodiments, the second actuator drives the cowling away from the first cowling position to push ice in the conduit against the grinding wheel.

Furthermore, in some embodiments, the cup de-nesting mechanism places the first cup in a starting position, and the indexer includes a rotating table that indexes the first cup from the starting position to the first position and that indexes the first cup from the first position to the second position. Further, in some embodiments, the second position is at an angle of 90 degrees from the first position. Even further, in various embodiments, the at least one first actuator further indexes the first cup from the second position to a third position where the frozen treat is discharged. Even further still, in certain embodiments, the indexer automatically indexes the first cup from the second position to a third position where the frozen treat can be retrieved. In a number of embodiments, the frozen treat dispenser further includes an ice maker that produces ice and dispenses the ice into the storage bin. Further, in particular embodiments, the frozen treat dispenser further includes an ice maker, which is part of an ice making and dispensing machine, and an ice transport mechanism that moves the ice from the ice maker to the storage bin.

In various embodiments, the flavor dispenser includes a pump assembly that withdraws flavoring fluid from a flavoring fluid container and pushes at least part of the withdrawn flavoring fluid to a dispensing head, and at least one check valve that prevents the withdrawn flavoring fluid from being reintroduced into the flavoring fluid container. Further, in certain embodiments, the flavor dispenser includes a pump assembly that withdraws at least one selected flavoring fluid from a plurality of flavoring fluid containers and pushes the at least one selected withdrawn flavoring fluid to a dispensing head, and a plurality of check valves that prevents the at least one selected withdrawn flavoring fluid from being reintroduced into a flavoring fluid container. Moreover, in particular embodiments of a frozen treat dispenser, the flavor dispenser includes a pump assembly that withdraws a plurality of flavoring fluids from a plurality of flavoring fluid containers and pushes the plurality of withdrawn flavoring fluids to a dispensing head, and a plurality of check valves that prevent the withdrawn flavoring fluids from being reintroduced into a flavoring fluid container.

In a number of embodiments, the frozen treat dispenser further includes a user selection panel to allow a user to pay for a frozen treat, and to select a flavor from a plurality of flavors. Still further, in some embodiments, the processor controls the operation of the cup de-nesting mechanism, the ice grinder, the flavor dispenser, and the indexer. Even further, various embodiments are configured to dispense snow cones and are configured to dispense slushies, and whether a snow cone or a slushy is produced is determined by a first amount of ice ground to produce snow and a second amount of flavoring liquid dispensed. In a number of embodiments, the treat dispenser is configured to allow a user to choose between a snow cone and a slushy.

### BRIEF DESCRIPTION OF THE DRAWINGS

FIGS. 1A and 1B are block diagrams of two exemplary environments for the frozen treat dispenser.

FIG. 2 is a diagram of an exemplary frozen treat dispenser.

FIG. 3 is a diagram of an exemplary ice grinding and dispensing mechanism.

FIGS. 4A-4C are diagrams of an exemplary cup de-nesting mechanism.

FIG. 5 is a diagram of an exemplary cup transport mechanism.

FIG. 6A is a diagram of an exemplary single flavor dispensing machine.

FIG. 6B is a diagram of an exemplary multiple-flavor dispensing machine.

FIG. 7 is a block diagram of an exemplary user selection and payment interface.

### DETAILED DESCRIPTION OF EXAMPLES OF EMBODIMENTS

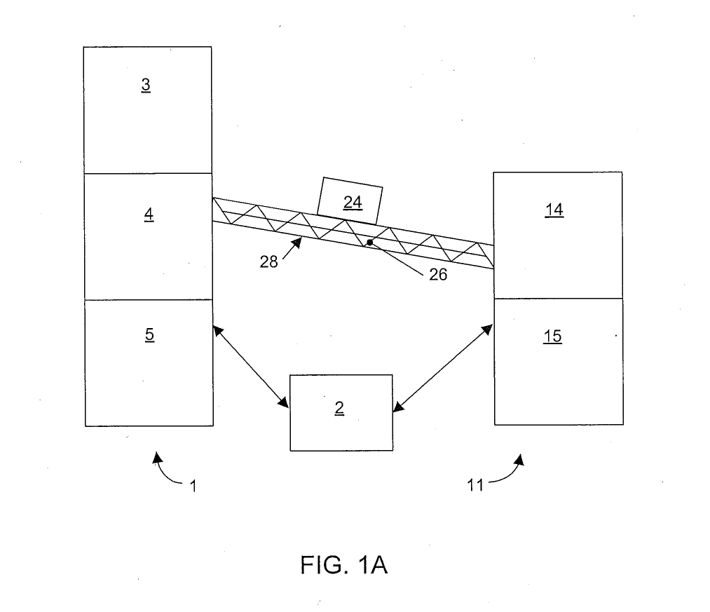

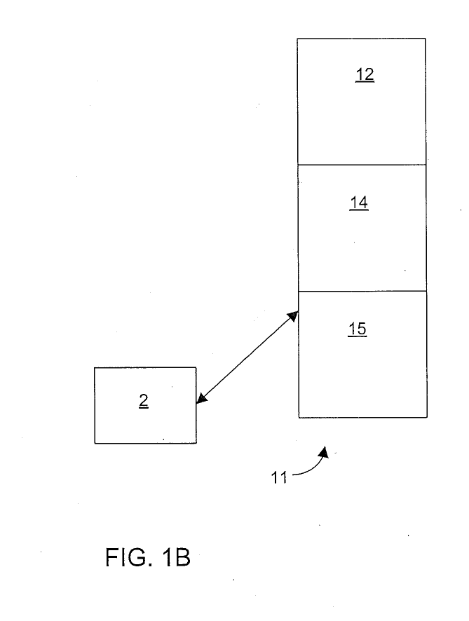

FIGS. 1A and 1B are block diagrams of two exemplary environments for a frozen treat dispenser 11 to produce and dispense a frozen treat, such as a snow cone or a slushy. In different embodiments, the frozen treat dispenser 11 can be used in conjunction with an ice making and dispensing machine 1 or as a stand-alone device.

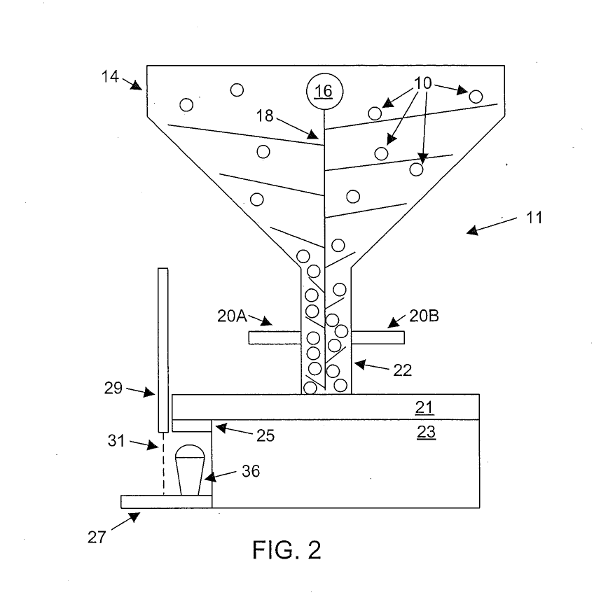

In some environments, as shown in FIG. 1A, the frozen treat dispenser 11 is used in conjunction with an ice making and dispensing machine 1. An exemplary ice making and dispensing machine 1 comprises an ice maker 3, an ice storage bin 4, an ice dispensing mechanism 5, and a user selection and payment interface 2. Ice making and dispensing machines are well known in the relevant art. In this environment, the frozen treat dispenser 11 includes an ice storage bin 14, and a cup dispensing, filling, flavoring mechanism 15. The ice maker 3 provides ice to the storage bin 4, and an auger 26, driven by a motor 24, pushes the ice from the storage bin 4 through the conduit 28 into the storage bin 14. The driver motor 24 may be controlled by a sensor 20A (FIG. 2) which senses the level of ice in the storage bin 14. Thus, in this implementation, the ice maker 3 provides the ice for both storage bins 4 and 14. In an alternative embodiment, the storage bin 14 is not used, and ice is provided directly from the storage bin 4 to the cup dispensing, filling, flavoring mechanism 15.

In another environment, as shown in FIG. 1B, the frozen treat dispenser 11 is a stand-alone device and includes an ice maker 12, an ice storage bin 14, a cup dispensing, filling, flavoring mechanism 15, and a user selection and payment interface 2.

FIG. 2 is a diagram of an exemplary frozen treat dispenser 11. An ice maker 3, 13 (FIGS. 1A, 1B) makes ice 10 which is deposited in the storage bin 14. A motor 16 and agitator 18 selectively break up and stir the ice 10 to allow it to pass down a feed passage 22. A sensor 20A or 20B, such as an electric eye or a mechanical switch, monitors the level of ice 10 in the passage 22 and turns on the motor 16 to keep the passage 22 filled to a predetermined level. In one embodiment, this predetermined level is the amount of ice that needs to be in the passage 22 to produce enough “snow” to fill a cup 36 to the desired level. In another embodiment, this predetermined level is the amount of ice that needs to be in the passage 22 to produce enough “snow” to fill two or more cups 36 to the desired level.

Ice 10 in the passage 22 is controllably allowed to drop into an ice grinding and dispensing mechanism 21 which grinds or crushes the ice to produce a fine ground or crushed ice, or “snow”, deposits the snow into a cup 36, and in some embodiments, also forms the snow at the top of the cup into a snowball shape.

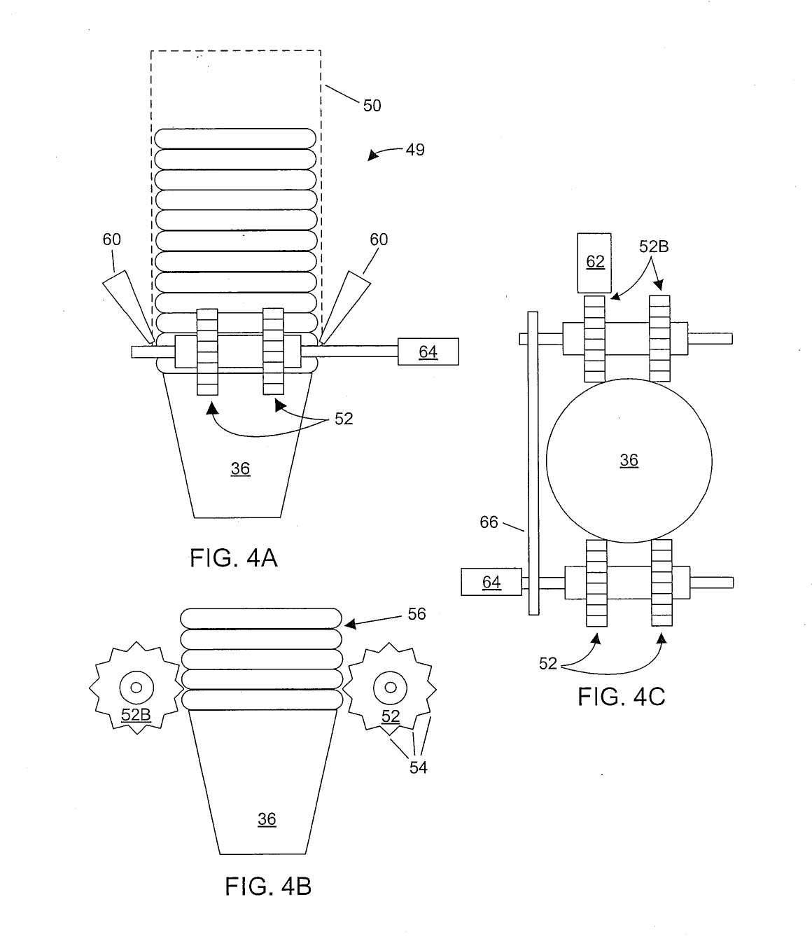

In some embodiments, a cup dispensing and transport mechanism 23 extracts a cup 36 from a plurality of stacked cups (FIGS. 4A-4C), moves the extracted cup into position for filling with snow by the mechanism 21, and moves the filled cup into position where a desired flavor or flavors can be added. A flavor dispensing mechanism 25, in this particular embodiment, deposits or sprays the desired flavor or flavors onto the snow in the cup 36 to produce a “snow cone” or in some embodiments, (e.g., if selected), a slushy.

The cup dispensing and transport mechanism 23, in this embodiment, then moves the snow cone or slushy into position on a customer service shelf 27, for example, whereby it can be reached and removed by a customer. In a number of embodiments, the various mechanisms mentioned herein are behind a wall or panel 29, and a door 31 is automatically opened, or can be manually opened by the customer, to allow the customer to retrieve the snow cone or slushy. Another option is for the movement of the cup to end once the flavors are applied to the snow. In some embodiments, a door 31 remains in a down or closed position until the flavors have been dispensed, and door 31 then opens for the customer to remove the snow cone or slushy, and then closes again. A sensor (e.g., infrared light or weight) can be used to provide a signal that the snow cone or slushy has been removed and that the door should be shut, in different embodiments, with or without a time delay.

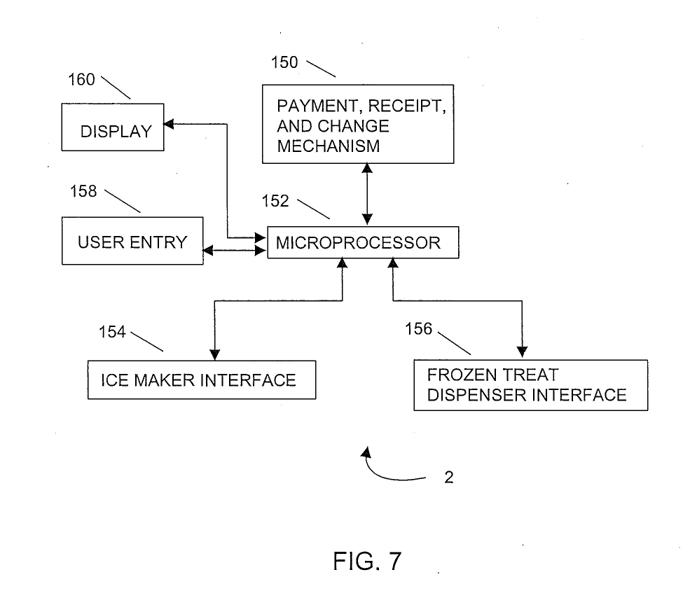

In various embodiments, operation of the various mechanisms is controlled by a controller, such as a microprocessor (FIG. 7) in the user selection and payment interface 2. Alternatively, the controller can be a separate component or can be included within a different mechanism, as convenient and desired. The controller, in a number of embodiments, includes a processor, memory, and input and output interface ports to allow the controller to receive information regarding the user selection, payment, ice levels in the storage bin(s) 4, 14, whether cups 36 are available, operational status of the machine as a whole and of parts thereof, etc., and to control the various mechanisms, including the ice maker(s) 2, 13, ice dispensing mechanism 5 of an ice making machine 1, the motor 16, the ice grinding and dispensing mechanism 21, the cup dispensing and transport mechanism 23, the flavor dispensing mechanism 25 and, in some embodiments, the door 23.

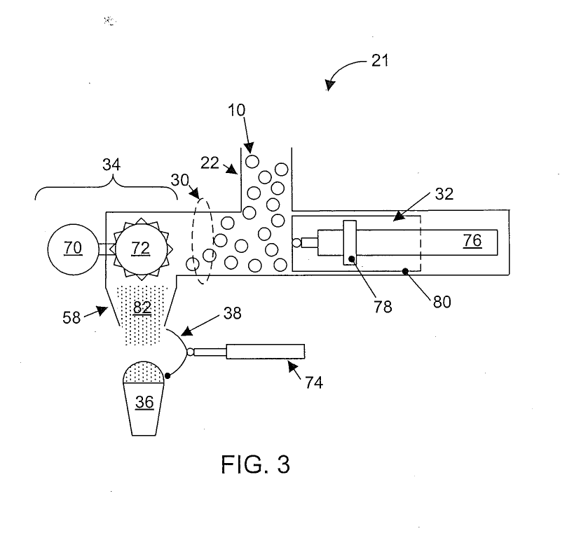

FIG. 3 is a diagram of an exemplary ice grinding and dispensing mechanism 21. As mentioned, a sensor 20A (FIG. 2) maintains the desired level of ice 10 in the feed passage 22. The ice 10 falls, or may be forced, such as through the operation of the agitator 18, through the feed passage 22 to a grinder feed conduit 30. A piston or compactor 32, in this particular embodiment, pushes the ice in the conduit 30 toward a grinder device 34, which finely grinds the ice to produce “snow” 82 which then falls through the fill chute 58 into the cup 36. A piston 38, in this embodiment, then presses the snow down into the cup 36.

The piston 32, in this embodiment, comprises an air actuated cylinder 76, position sensor 78, and cowling 80. The cowling is connected to the cylinder and, when the cylinder is actuated (e.g., extended), the cowling 80 moves to push the ice in the conduit 30 toward and against the grinder blades 72. A motor 70, in the embodiment illustrated, turns the grinder blades to grind the ice into snow 82, which falls through the fill chute 58 into the cup 36. The sensor 78 determines how much ice has been pushed toward, and ground into snow by, the grinder blades. Once the desired amount has been ground, the cylinder 76 is retracted, and pulls the cowling 80 back, and the motor 70 is turned off. When the cowling 80 is retracted, ice in the passage 22 can fall into, and refill, the conduit 30.

In an alternative embodiment, the cylinder 76 and cowling 80 begin in the extended position, retract to allow ice 10 to drop from passage 22 into conduit 30, and then extend again to push the ice 10 in the conduit 30 toward the grinder 34. This embodiment serves to minimize the residual ice in conduit 30, thereby reducing the likelihood that a solid block of ice will form in the conduit 30. Further, in other embodiments, where a pneumatic cylinder (e.g., 76) is described herein, another type of actuator can be used. Examples include electric motors and electric solenoids. Various embodiments use at least one actuator.

In the embodiment illustrated, once the proper amount of ice has been ground into snow, an air cylinder 74 is actuated to extend, thereby causing the compactor 38 to press the snow 82 down into the cup. The cylinder 74 is then retracted, which pulls the compactor 38 away from the cup 36. This allows the cup 36 to be removed and a next cup 36 to be placed into position and filled. In a number of embodiments, for aesthetic reasons, the compactor 38 is in the shape of a hemisphere so as to give the top of the snow cone a pleasing, rounded appearance.

FIGS. 4A-4C are diagrams of an exemplary cup de-nesting mechanism 49. A cup magazine 50 holds a plurality of stacked (nested) cups 36. A plurality of de-nesting sprockets 52, 52B have teeth 54 arranged, in the embodiment illustrated, so as to match the spacing of the cups 36 and to fit in the gap 56 between two cups 36. The teeth 54 separate the bottom cup from the stack of nested cups and two air jets 60, in this particular embodiment, directed toward the gap 56 between the cups, provide a burst of air which helps to complete the separation and to force the bottom cup down into position 40A for filling.

A motor 64, in this embodiment, drives the sprockets 52. A sprocket drive mechanism 66, such as but not limited to a chain or a direct drive, links the sprockets 52 on one side of the cup 36 to opposing sprockets 52B on the opposite sides of the cup 36. This provides separating forces, in this particular embodiment, on opposite sides of the cup, so that the cup is separated and dispensed and does not twist or tilt and cause a jam. Alternatively, instead of drive 66, in some embodiments, separate motors, such as stepper motors, are used to independently drive the sprockets 52 and 52B. Further, other separation/drive arrangements are possible, such as separating the cups at three, four, five or six distinct points rather than the four points shown herein.

A sensor 62, in the embodiment shown, such as but not limited to a magnetic sensor, is responsive to the presence (or absence) of the teeth 54 of the sprocket near the sensor 62. Sensor 62 can therefore provide a signal to a controlling mechanism, such as but not limited to a microprocessor or logic circuitry, which can then cause the sprockets 52 and 52B to rotate just enough to cause a single cup 36 to be dispensed and cause the jets 60 to provide the burst of air for separation. The signal provided by the sensor 62 can also be used for counting the total number of cups 36 which have been dispensed so as to provide an indication, if desired, that the cup magazine 50 should be refilled.

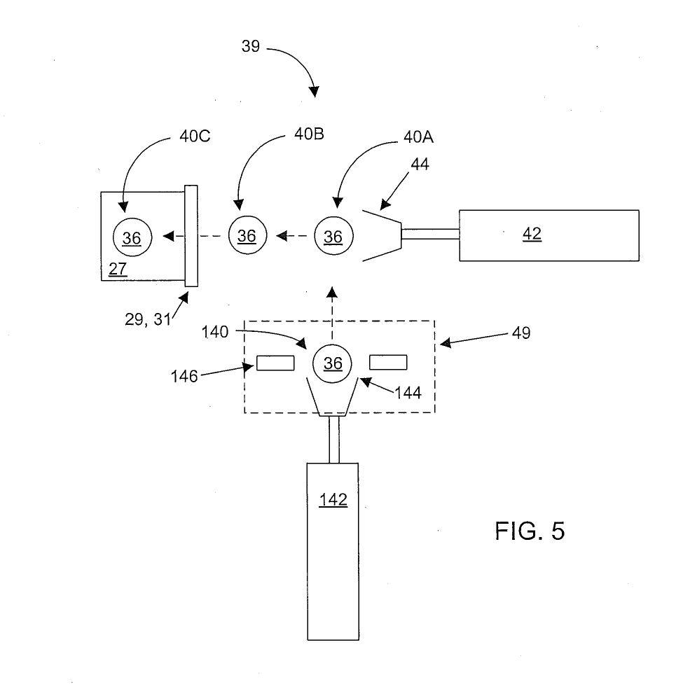

FIG. 5 is a diagram of an exemplary cup indexer or cup transport mechanism 39. In the embodiment illustrated, a cup 36 is initially dispensed into starting position 140 by the cup dispensing mechanism 49, indicated by the dashed box. A sensor 146, in this embodiment, verifies that a cup 36 has been dropped into starting position 140. A pneumatic air cylinder 142 is then activated, in this particular embodiment, to extend and cause a pusher 144 to push (index) the cup 36 into position 40A to be filled with snow. In other embodiments, a different type of actuator can be used. The cup dispensing mechanism 49, in a number of embodiments, then separates and drops another cup 36 into starting position 140 while other operations (snow filling, flavor dispensing) are in process for the previously-dropped cup.

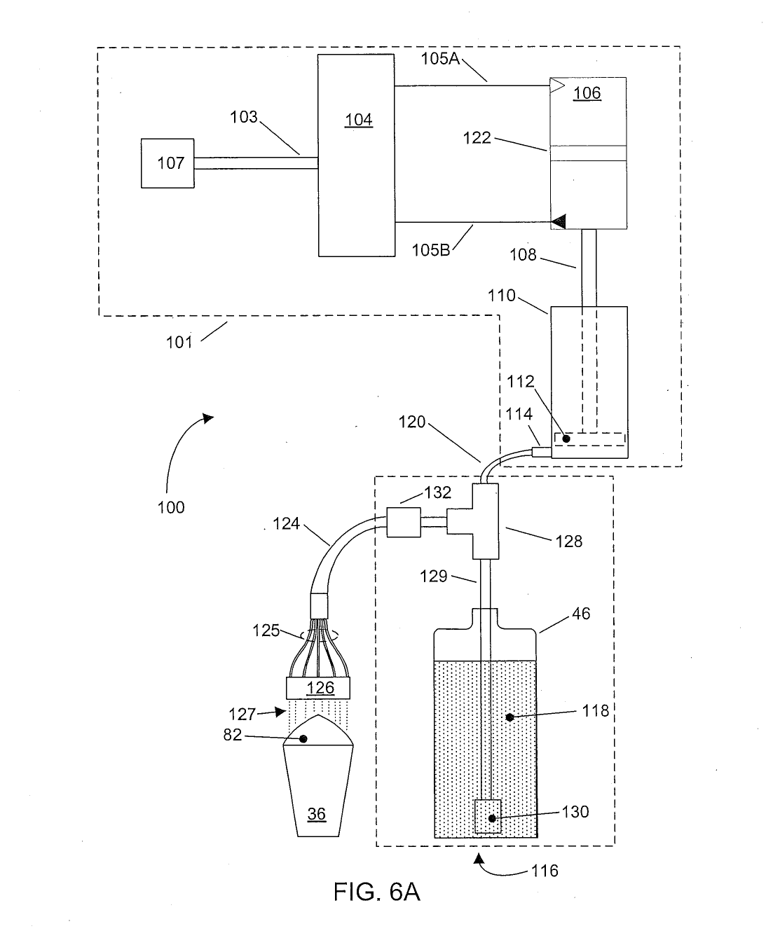

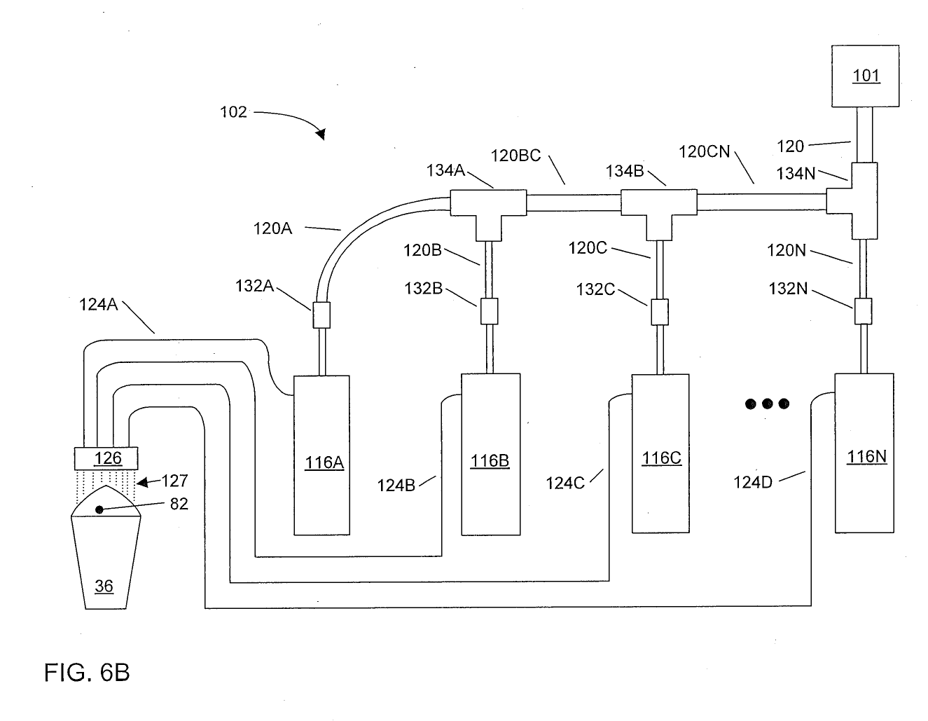

A pneumatic piston 42, in the embodiment illustrated, is then actuated to extend and cause a cup pusher 44 to index the cup 36 from snow filling position 40A to flavor dispensing position 40B. Other embodiments use a different type of actuator. One or more desired flavors are then withdrawn from the flavor canisters 46 (FIG. 6A), in some embodiments, and dispensed by a dispensing head 126 (FIGS. 6A, 6B) onto the snow in the cup 36. The piston 42, its, then causes the cup pusher 44 to index the cup 36 from the flavor dispensing position 40B to the customer retrieval position 40C on the customer service shelf 27. The piston 42 then retracts the cup pusher 44, in the embodiment shown, so as to allow a next cup to be indexed to position 40A.

The use of two separate mechanisms (e.g., in the cup indexer), one mechanism (49, 142, 144, 146) to dispense the cup to a position 140 and index it to position 40A, and another mechanism (42, 44) to index the cup from position 40A to position 40C, in a number of embodiments, allows the travel path of the cup to be folded, thereby conserving space and reducing the length of the overall machine, and also allows for a cup to be dispensed and ready for indexing even while a previously-dispensed cup is being indexed, filled with snow, and drenched in flavoring syrup. As previously mentioned, another option is to allow the customer to retrieve the snow cone or slushy from position 40B after the flavoring fluid has been dispensed, thereby eliminating the need to index the cup to position 40C. Further, other embodiments include other types of cup indexers.

In some embodiments, a rotating table, for example, driven by an electric motor, advances the cups (e.g., 36). A rotating table is another example of an actuator. Further, a rotating table is another example of an indexer. Further, a motor driving a rotating table is another example of an actuator. In particular embodiments having a rotating table, for instance, air cylinders are not used. In certain embodiments, the rotating table has multiple locations, recesses, projections, guides, or indentations to hold (e.g., multiple) cups. Further, in a number of embodiments, the rotating table stops in multiple positions. In some embodiments, in a starting position, a cup is dropped onto the rotating table. The table then rotates, in some embodiments, until the cup is in a first position, where the cup is filled with snow. In a number of embodiments, the table stops when the cup is in various (e.g., each) of the positions. Further, in some embodiments, in a second position, the flavoring is dispensed into the cup (i.e., into the snow that is in the cup). Further still, in a number of embodiments, the rotating table has a third position, where the cup is removed or discharged from the table (e.g., manually by the customer or automatically, in different embodiments).

In this example, the rotating table has four positions, the starting position and the first, second, and third positions. In some embodiments, the four positions are 90 degrees apart around the rotating table. As used herein, 90 degrees apart means within plus or minus 10 degrees. In other embodiments, the actuator or table may have another number of positions, such as 2, 3, 5, 6, 7, 8, 9, 10, 11, or 12 positions, as examples. Some embodiments have a corresponding angle between positions (e.g., 360 degrees divided by the number of positions). In some embodiments, different cups are (or can be) in different of positions on the rotating table at the same time, for example, so that one cup is being dropped onto the table, while another cup is being filled with snow, while another cup is having the flavoring added, and while another cup is being discharged. In a number of embodiments, however, a cup is not filled with ice until it is ordered by the customer, to avoid having the ice sit and melt in the cup.

FIG. 6A is a diagram of an exemplary single flavor dispensing machine 100. An air valve 104 is connected via an air line 103 to an air supply 107 and to a controller, such as a microprocessor (FIG. 7). The air supply 107 is a motor-driven air pump, in a number of embodiments, but in other embodiments, can be another source of pressurized air. The air valve 104 has two outputs which are connected via air lines 105A and 105B to two corresponding input control ports of air cylinder 106. When the air valve 104 is actuated into one position, the air supply is connected to line 105B, which causes the shaft 108 of air cylinder 106 to retract. The shaft 108 is connected to the plunger 112 of cylinder 110. Thus, when the shaft of cylinder 106 retracts, it pulls the plunger 112 toward the top of cylinder 110, thereby creating a vacuum at port 114. This vacuum pulls the flavoring liquid 118 through line 129 out of the bottle 46 and into line 120. A position sensor 122 measures the volume of the liquid 118 which has been withdrawn by monitoring, for example, how far the shaft has been retracted. When the sensor 122 indicates that the correct liquid volume has been withdrawn, the air valve 104 is reversed, which causes the air supply to be connected to line 105A, which causes the shaft 108 of air cylinder 106 to extend. This pushes the plunger 112 toward the bottom of cylinder 110, therefore creating a positive pressure at port 114. This positive pressure forces the liquid in line 120 through Tee 128 and a check valve 132 into line 124. The liquid then goes through lines 125 into a dispensing head 126, which, in a number of embodiments, has several openings for dispensing of the liquid 127 onto the snow 82 in the cup 36. The check valve 132 allows fluid to be forced to the dispenser head 126, but prevents air or fluid from being drawn back into line 124 so that a vacuum at port 114 can draw the fluid 118 from the bottle 46, thereby preventing contamination of the fluid 118.

A check valve 130 allows fluid 118 to be drawn into line 129 and then into line 120, but prevents liquid in lines 120 and 129 from being re-injected into the bottle 46, thereby preventing contamination of the fluid 118. Although the check valve 130 is shown as being at the end of the line 129 it may be at any point in line 129 or even between the Tee 128 and the line 129. In various embodiments, the fluid 118 is drawn out of the bottle 46 just prior to being dispensed onto the snow 82. This helps to prevent the fluid 118 from drying in the lines or becoming contaminated. For convenience, components 103, 104, 105A, 105B, 106, 107, 108, 110, 112, 114 and 122 are referred to herein as a pumping assembly 101. Also for convenience, components 46, 118, 128, 129, 130 and 132 are referred to herein as a fluid extraction assembly 116.

FIG. 6B is a diagram of an exemplary multiple-flavor dispensing machine 102. This machine has 4 single flavor setups and 1 multi-flavor setup, although more or fewer flavors may be provided in other embodiments. The exemplary multiple-flavor dispensing machine 102 is similar in construction and operation to the single flavor dispensing machine 100 but there are multiple fluid extraction assemblies 116 and associated lines, Tees, and check valves. In this particular embodiment, tees 134A, 134B and 134N split line 120 into N different lines, 120A, 120B, 120C, and 120N, each of which is connected to a corresponding fluid extraction assembly 116A-116N through an intermediate check valve 132A, 132B, 132C and 132N. The Tees 134 allow the vacuum and pressure from pumping assembly 101 to draw the flavoring fluid 118 from the bottles 46 and then to force the flavoring fluid through lines 124A, 124B, 124C and 124N to and through the dispenser head 126. The check valves 132A-132N prevent fluid drawn from, for example, bottle 46 of fluid extraction assembly 116A from being forced into, for example, bottle 46 of fluid extraction assembly 116C. This prevents cross-contamination of the flavoring fluids 118. In the embodiment shown, N is four, that is, there are four flavors. In other embodiments, there are 2, 3, 5, 6, 7, or 8 flavors, as other examples.

In a number of embodiments, using the user selection and payment interface 2, for example, the user can select a single flavor, or all flavors can be selected. As each flavor has a different distinct color, in various embodiments, the user, by selecting all flavors, can select a “rainbow” of flavors. In some embodiments, the “rainbow” multi-flavor selection operates in a manner similar to that of the single flavor machine 100 but flavoring syrup is now drawn from all bottles at once, and the flavors are dispensed into in the cup, for example, for aesthetic purposes, in quadrants. Other embodiments, however, may differ.

In other embodiments, two or three flavors may be selected. Operation is similar to the above, but controllable valves (not shown) are placed, in some embodiments, between the Tees 134 and the Tees 128 in the fluid extraction assemblies 116. The controllable valves, in certain embodiments, selectively allow the vacuum to withdraw a particular flavor from a particular bottle 46, or the pressure to be applied to force the withdrawn liquid into the dispenser head 126. The controllable valves could be, for example, part of the check valves 132 or could be separate from the check valves 132. The controllable valves are controlled by the microprocessor (FIG. 7), in some embodiments, for example, in the user selection and payment interface 2.

A “slushy” has a higher liquid-to-snow ratio than a snow cone and acts more like a fluid than a solid in that it does not hold its shape and, if the cup 36 is tilted, the liquid/ice mixture will tend to flow over the sides of the cup, especially if the cup is overfilled, that is, above the lip or rim of the cup 36. Therefore, for a slushy, the amount of ice that is ground into snow is reduced, in a number of embodiments, so that the cup 36 is not overfilled. The amount of ice that is to be ground can be controlled, in some embodiments, by adjusting the degree to which the cowling 80 is retracted to allow the ice 10 to fall into the conduit 30. Also, the amount of flavoring liquid that is dispensed is increased, in some embodiments, to achieve the desired texture. The amount of flavoring liquid can be controlled, for example, by using the sensor 122 to control the degree of retraction of the plunger 112. Other techniques can be used, in other embodiments, to control the amount of ice and flavoring liquid. Also, for a slushy, the compactor 38 generally would not be used, in a number of embodiments, as the slushy would not hold the shape very well. Although, in a number of embodiments, the frozen treat dispenser can produce either a snow cone or a slushy, according the customer's selection, in some embodiments, the frozen treat dispenser can be configured so as to only produce a snow cone, or only produce a slushy.

Other embodiments include various methods, for example, of producing a frozen treat, such as a snow cone or a slushy. Various embodiments include, as examples, producing and storing ice, accepting a selection of at least one flavor of a plurality of flavors for the frozen treat, automatically separating a cup from a stack of cups, grinding ice to produce snow, depositing the snow into the cup, moving the cup from the position where the snow was deposited to another position, dispensing at least one flavoring fluid onto the snow in the cup, or a combination thereof.

FIG. 7 is a block diagram of an exemplary user selection and payment interface 2. Payment, receipt, and change mechanism 150 allows the user to pay using, for example, cash, credit card, or debit card, and, in some embodiments, provides change and/or a receipt. Such mechanisms are well known in the art. The user entry device 158, in various embodiments, allows the user to select a snow cone or a slushy and to specify a single flavor or multiple flavors, and which flavors. If the dispenser 11 is part of an ice making and dispensing machine, then the user can also select the quantity of ice and how the ice is to be delivered (bagged, or via a chute). The user entry device 158 may be a keypad and/or a touchscreen, as examples, or other device which allows the user to make the desired selection(s).

The display device 160, in the embodiment illustrated, provides information to the customer as to what options are available, the status of the machine (working, out of one or more flavors, out of ice, out of order, no change, cash only, credit/debit card only, etc.), and an indication of what the user has paid or selected. The display device 160 may be, for example, an LED display, a screen, or a touchscreen. As indicated above, in some embodiments, the user entry device 158 and the display device 160 may be a single device. The ice maker interface 154, in the embodiment shown, allows the microprocessor to receive signals from, and send signals to, the icemaking machine in order to monitor the status of the icemaking machine and to control the operation of the icemaking machine. Such interfaces are well known.

The frozen treat dispenser interface 156, in the embodiment depicted, allows the microprocessor to receive signals from, and send signals to, the frozen treat dispenser in order to monitor the status of the frozen treat dispenser and to control the operation of the frozen treat dispenser. Although a frozen treat dispenser as described herein is not known in the art, and therefore the specifics of the interface are not known in the art, such an interface would be similar to the icemaker interface 154 and the design of such an interface can be implemented by one of ordinary skill in the art after reading the detailed description herein of the operation of the frozen treat dispenser. The microprocessor 152, as previously mentioned, monitors and controls the operation of the user entry device 158, the display 160, the payment, receipt and change mechanism 150, the frozen treat dispenser through the frozen treat dispenser interface 156 and, optionally, the ice maker machine through the ice marker interface 154. In a number of embodiments, electrical power, a water supply, and a line for disposing of liquid waste are provided, but are not shown.

In a number of embodiments, the microprocessor 152 includes, or is connected to, a memory containing operating instructions for the processor. The memory can also contain information about the operating status and history of the ice maker or the frozen treat dispenser. The user selection and payment interface 2 may also contain a modem (not shown) and/or an Internet connection (not shown) and/or a wireless connection (not shown), if desired, for reporting the operating status and history of the machine to the owner, a repair facility, and/or a maintenance facility, and/or for receiving operating instructions, new prices, updates, etc., from the owner, a repair facility, and/or a maintenance facility. In various embodiments, either as a standalone machine or associated with an ice making and dispensing machine, and either dispending a single-flavor or multiple-flavors, the machines 100, 102 provide for convenient and quick creation and dispensing of a snow cone or a slushy.

A number of embodiments are a frozen treat dispenser (e.g., 11) to dispense a frozen treat, such as a snow cone or a slushy, or both. Various embodiments, include an ice storage bin (e.g., 4 or 14), a cup de-nesting mechanism (e.g., 49) that separates a first cup (e.g., 36) from a stack having a plurality of cups, an ice grinder (e.g., ice grinding and dispensing mechanism 21) that grinds ice from the ice storage bin producing snow (I., 82), a flavoring liquid dispenser (e.g., flavor dispensing mechanism 25) that dispenses flavoring liquid (I., 127) into the snow, an indexer (e.g., cup indexer or cup transport mechanism 39) that moves the first cup to a first position where the ice grinder at least partially fills the first cup with the snow and to a second position where the flavoring liquid dispenser dispenses at least one flavoring liquid onto the snow in the first cup, and a processor (e.g., microprocessor 152) controlling the operation of at least one of the cup de-nesting mechanism, the ice grinder, the flavoring liquid dispenser, or the indexer. In a number of embodiments, the cup de-nesting mechanism places the first cup in a starting position, and the indexer includes at least one first actuator that indexes the first cup from the starting position to the first position and that indexes the first cup from the first position to the second position.

In some embodiments, the cup de-nesting mechanism (e.g., 49) includes a plurality of spaced-apart sprockets (e.g., 52 and 52B), each sprocket having a plurality of teeth (e.g., 54). In a number of embodiments, the teeth are interposed between a lip of the first cup and a lip of a next cup in the stack. Some embodiments further include at least one first motor (e.g., 64) driving the sprockets in a direction to cause the teeth to engage the lip of the first cup and urge the first cup away from the stack. Further, a number of embodiments include a plurality of air jets (e.g., 60) directing air between the first cup and the next cup in the stack and urging the first cup away from the stack. Further, in some embodiments, a first pair of sprockets (e.g., 52) are on a first shaft and are generally disposed on one side of the first cup and a second pair of sprockets (e.g., 52B) are on a second shaft and are generally disposed on an opposite side of the first cup from the one side. Moreover, in some embodiments, the at least one first motor is connected to a least one of the first shaft or the second shaft. Further still, some embodiments further include a sprocket drive mechanism (e.g., 66), for example, and the at least one first motor drives the first shaft and the sprocket drive mechanism, and the sprocket drive mechanism drives the second shaft. Even further, in various embodiments, the sprocket drive mechanism is either a chain drive or a direct drive, as examples.

Moreover, in a number of embodiments, the ice grinder (e.g., ice grinding and dispensing mechanism 21) includes a conduit (e.g., grinder feed conduit 30) having a first opening (e.g., or passage 22) that receives the ice (e.g., 10) from the ice storage bin (e.g., 4 or 14), Additionally, a number of embodiments include a second opening (e.g., above fill chute 58) that discharges the snow, a grinding wheel (e.g., 72) that grinds the ice to produce the snow, a second motor (e.g., 70) that drives the grinding wheel, or a combination thereof. Various embodiments further include a cowling (e.g., 80), for instance, at least partially inside the conduit (e.g., 30) that allows the ice from the ice storage bin, for example, to enter the conduit via the first opening when the cowling is in a first cowling position. Moreover, in some embodiments, the cowling pushes ice, for example, in the conduit, against the grinding wheel, for instance. In a number of embodiments, a second actuator (e.g., air cylinder 76) drives the cowling, for example. A number of embodiments include a chute (e.g., fill chute 58) that directs the snow, for instance, from the second opening toward the first cup (e.g., 36). Further, some embodiments include a shaping mold (e.g., compactor 38) that forms snow in the first cup into a desired shape (e.g., a hemisphere) and a third actuator (e.g., air cylinder 74) that drives the shaping mold against the snow in the first cup. Further still, in some embodiments, the second actuator drives the cowling away from the first cowling position to push ice in the conduit against the grinding wheel.

Furthermore, in some embodiments, the cup de-nesting mechanism places the first cup (e.g., 36) in a starting position, and the indexer includes a rotating table, for example, that indexes the first cup from the starting position to the first position, that indexes the first cup from the first position to the second position, or both. Further, in some embodiments, the second position is at an angle of 90 degrees from the first position. Even further, in various embodiments, the at least one first actuator further indexes the first cup from the second position to a third position, for example, where the frozen treat is discharged. Even further still, in certain embodiments, the indexer automatically indexes the first cup from the second position to a third position where the frozen treat can be retrieved (e.g., by the user or customer). In a number of embodiments, the frozen treat dispenser further includes an ice maker (e.g., 3) that produces ice (e.g., 10). In some embodiments, for example, the ice maker dispenses the ice into the storage bin (e.g., 4 or 14). Further, in particular embodiments, the frozen treat dispenser includes an ice maker (e.g., 3), which is part of an ice making and dispensing machine (e.g., 1), and an ice transport mechanism (e.g., auger 26, driven by a motor 24, that pushes the ice from the storage bin 4 through the conduit 28) that moves the ice, for instance, from the ice maker to the storage bin.

In various embodiments, the flavor dispenser includes a pump assembly (e.g., flavor dispensing machine 100) that withdraws flavoring fluid from a flavoring fluid container (e.g., flavoring liquid bottle 46) and pushes at least part of the withdrawn flavoring fluid to a dispensing head. A number of embodiments include at least one check valve (e.g., 130), for example, that prevents the withdrawn flavoring fluid from being reintroduced into the flavoring fluid container. Further, in certain embodiments, the flavor dispenser includes a pump assembly (e.g., flavor dispensing machine 102) that withdraws at least one selected flavoring fluid from a plurality of flavoring fluid containers and pushes the at least one selected withdrawn flavoring fluid to a dispensing head, and a plurality of check valves that prevents the at least one selected withdrawn flavoring fluid from being reintroduced into a flavoring fluid container, as another example. Moreover, in particular embodiments of a frozen treat dispenser, the flavor dispenser includes a pump assembly that withdraws a plurality of flavoring fluids from a plurality of flavoring fluid containers and pushes the plurality of withdrawn flavoring fluids to a dispensing head, and a plurality of check valves that prevent the withdrawn flavoring fluids from being reintroduced into a flavoring fluid container.

In a number of embodiments, the frozen treat dispenser further includes a user selection panel (e.g., user selection and payment interface 2) to allow a user to pay (e.g., via payment, receipt, and change mechanism 150, for instance, with cash or a credit or debit card, as examples) for a frozen treat, and to select a flavor from a plurality of flavors. Still further, in some embodiments, the processor (e.g., 152) controls the operation of the cup de-nesting mechanism, the ice grinder, the flavor dispenser, and the indexer. Even further, various embodiments are configured (e.g., via programming) to dispense snow cones and are also configured to dispense slushies. In a number of embodiments, whether a snow cone or a slushy is produced is determined, for example, by a first amount of ice ground to produce snow and a second amount of flavoring liquid that is dispensed. In a number of embodiments, the treat dispenser is configured (e.g., user selection and payment interface 2 is configured) to allow a user to choose between a snow cone and a slushy, for example.

Consider now the operation of an example machine described herein.
(A) An icemaker 12 makes ice 10 to fill a storage section 14 and feed passage 22; and a motor 16 and agitator 18 keep the ice stirred and fragmented. A sensor 20A controls the icemaker 12, directly or via the processor 152, to maintain ice in the storage section 14 and feed passage 22. (FIGS. 1B, 2)
(B) A motor 64, sprockets 52, and air jets 60 dislodge a cup 36 from a nest of stacked cups so that it falls into the starting position 140 and then is indexed to position 40A beneath the fill chute 58. (FIGS. 4A-4C, 5)
(C) When the customer makes the selection of a snow cone or a slushy, and the desired flavor(s) and inserts the correct payment, an air cylinder 76, sensor 78, and cowling 80 operate to push a determined amount of ice through the conduit 30 toward the grinding mechanism 34. (FIG. 2)
(D) The motor 70 and grinder 72 of mechanism 34 grind the ice 10 into snow, which falls through chute 58 into the cup 36. (FIG. 3)
(E) A cylinder 74 forces a compactor 38 to compact the snow 82 down into the cup 36 if a snow cone is desired. (FIG. 3)
(F) A piston 42 and cup pusher 44 then push the cup 36 from snow dispensing position 40A to flavor dispensing position 40B. (FIG. 5)
(G) An air valve 104 and sensor 122 cause cylinders 106 and 110 to withdraw a determined amount of fluid from flavoring liquid bottle 46. The air valve 104 and cylinders 106 and 110 then cause this withdrawn liquid to be forced through dispenser head 126 onto the snow 82. (FIGS. 6A, 6B)
(H) The piston 42 and cup pusher 44 then push the cup 36 from flavor dispensing position 40B to customer retrieval position 40C; and then piston 42 and pusher 44 retract to the starting position 40A, ready for another cup to drop. (FIG. 5)

It should be noted that, if desired, step (B) can occur after the customer has made payment.

In a number of embodiments, but not necessarily, the machine also dispenses a spoon or straw to the customer.

In some embodiments, the cup is dispensed and indexed into the staging position 140 even before the customer pays the money and selects the flavor.

In various embodiments, the icemaker 12 is the icemaker 3 in an ice vending machine.

In various embodiments, the machine therefore provides the option for a customer to obtain a delicious snow cone or slushy when the customer comes to get ice from the machine.

Unless otherwise indicated, all sizes, amounts, value, styles, dimensions, and physical properties mentioned in the specification and/or drawing are exemplary and are not critical. Thus, for example, a length of 2 inches, or a voltage rating of 110 VAC, or a component manufacturer and model number, power rating, etc., are exemplary and not limitations.

Those skilled in the art will recognize, or be able to ascertain using no more than routine experimentation, numerous equivalents to the specific procedures described herein. Such equivalents are considered to be within the scope of the invention. Various substitutions, alterations, and modifications may be made to the invention without departing from the spirit and scope of the invention. Other aspects, advantages, and modifications are within the scope of the invention. Accordingly, the scope of the invention is to be limited only by the claims below and the equivalents thereof.

What is claimed is:

1. A frozen treat dispenser, comprising:
an ice storage bin;
a cup de-nesting mechanism that separates a first cup from a stack having a plurality of cups;
an ice grinder that grinds ice from the ice storage bin producing snow;
a flavoring liquid dispenser that dispenses flavoring liquid into the snow;
an indexer that moves the first cup to a first position where the ice grinder at least partially fills the first cup with the snow and to a second position where the flavoring liquid dispenser dispenses at least one flavoring liquid onto the snow in the first cup; and
a processor controlling the operation of at least one of the cup de-nesting mechanism, the ice grinder, the flavoring liquid dispenser, or the indexer;
wherein the cup de-nesting mechanism places the first cup in a starting position, and the indexer comprises at least one first actuator that indexes the first cup from the starting position to the first position and that indexes the first cup from the first position to the second position.

2. The frozen treat dispenser of claim 1 wherein the cup de-nesting mechanism comprises:
a plurality of spaced-apart sprockets, each sprocket having a plurality of teeth, the teeth being interposed between a lip of the first cup and a lip of a next cup in the stack;
at least one first motor driving the sprockets in a direction to cause the teeth to engage the lip of the first cup and urging the first cup away from the stack; and
a plurality of air jets directing air between the first cup and the next cup in the stack and urging the first cup away from the stack.

3. The frozen treat dispenser of claim 2 wherein a first pair of sprockets are on a first shaft and are generally disposed on one side of the first cup and a second pair of sprockets are on a second shaft and are generally disposed on an opposite side of the first cup from the one side, the at least one first motor being connected to a least one of the first shaft or the second shaft.

4. The frozen treat dispenser of claim 3 further comprising a sprocket drive mechanism, the at least one first motor driving the first shaft and the sprocket drive mechanism, and the sprocket drive mechanism driving the second shaft.

5. The frozen treat dispenser of claim 4 wherein the sprocket drive mechanism is either a chain drive or a direct drive.

6. The frozen treat dispenser of claim 1 wherein the ice grinder comprises:
a conduit having a first opening that receives the ice from the ice storage bin and a second opening that discharges the snow;
a grinding wheel that grinds the ice to produce the snow;
a second motor that drives the grinding wheel;
a cowling, at least partially inside the conduit, that allows the ice from the ice storage bin to enter the conduit via the first opening when the cowling is in a first cowling position, and that pushes ice in the conduit against the grinding wheel;
a second actuator that drives the cowling; and
a chute that directs the snow from the second opening toward the first cup.

7. The frozen treat dispenser of claim 6 further comprising:
a shaping mold that forms snow in the first cup into a desired shape; and
a third actuator that drives the shaping mold against the snow in the first cup.

8. The frozen treat dispenser of claim 6 wherein the second actuator drives the cowling away from the first cowling position to push ice in the conduit against the grinding wheel.

9. The frozen treat dispenser of claim 1 wherein the cup de-nesting mechanism places the first cup in a starting position, and the indexer comprises a rotating table that indexes the first cup from the starting position to the first position and that indexes the first cup from the first position to the second position.

10. The frozen treat dispenser of claim 9 wherein the second position is at an angle of 90 degrees from the first position.

11. The frozen treat dispenser of claim 1 wherein the at least one first actuator further indexes the first cup from the second position to a third position where the frozen treat is discharged.

12. The frozen treat dispenser of claim 1 wherein the indexer further automatically indexes the first cup from the second position to a third position where the frozen treat can be retrieved.

13. The frozen treat dispenser of claim 1 an further comprising an ice maker that produces ice and dispenses the ice into the storage bin.

14. The frozen treat dispenser of claim 1 further comprising an ice maker which is part of an ice making and dispensing machine, and an ice transport mechanism that moves the ice from the ice maker to the storage bin.

15. The frozen treat dispenser of claim 1 wherein the flavor dispenser comprises a pump assembly that withdraws flavoring fluid from a flavoring fluid container and pushes at least part of the withdrawn flavoring fluid to a dispensing head, and at least one check valve that prevents the withdrawn flavoring fluid from being reintroduced into the flavoring fluid container.

16. The frozen treat dispenser of claim 1 wherein the flavor dispenser comprises a pump assembly that withdraws at least one selected flavoring fluid from a plurality of flavoring fluid containers and pushes the at least one selected withdrawn flavoring fluid to a dispensing head, and a plurality of check valves that prevents the at least one selected withdrawn flavoring fluid from being reintroduced into a flavoring fluid container.

17. The frozen treat dispenser of claim 1 wherein the flavor dispenser comprises a pump assembly that withdraws a plurality of flavoring fluids from a plurality of flavoring fluid containers and pushes the plurality of withdrawn flavoring fluids to a dispensing head, and a plurality of check valves that prevent the withdrawn flavoring fluids from being reintroduced into a flavoring fluid container.

18. The frozen treat dispenser of claim 1 further comprising a user selection panel to allow a user to pay for a frozen treat, and to select a flavor from a plurality of flavors.

19. The frozen treat dispenser of claim 1 wherein the processor controls the operation of the cup de-nesting mechanism, the ice grinder, the flavor dispenser, and the indexer.

20. The frozen treat dispenser of claim 1 configured to dispense snow cones and configured to dispense slushies wherein whether a snow cone or a slushy is produced is determined by a first amount of ice ground to produce snow and a second amount of flavoring liquid dispensed and wherein the treat dispenser is configured to allow a user to choose between a snow cone and a slushy.
